(19) United States
(12) Patent Application Publication
(10) Pub. No.: US 2023/0123100 A1
(43) Pub. Date: Apr. 20, 2023

(54) IMPELLER AND CENTRIFUGAL COMPRESSOR

(71) Applicant: Mitsubishi Heavy Industries Marine Machinery & Equipment Co., Ltd., Nagasaki-shi, Nagasaki (JP)

(72) Inventors: Hironori Honda, Tokyo (JP); Nao Taniguchi, Tokyo (JP); Fumito Hiratani, Tokyo (JP); Isao Tomita, Tokyo (JP); Tetsuya Matsuo, Nagasaki-shi (JP); Taiyo Shirakawa, Nagasaki-shi (JP)

(73) Assignee: Mitsubishi Heavy Industries Marine Machinery & Equipment Co., Ltd., Nagasaki-shi, Nagasaki (JP)

(21) Appl. No.: 17/914,467

(22) PCT Filed: Apr. 21, 2021
(86) PCT No.: PCT/JP2021/016172

§ 371 Date: Sep. 26, 2022

(30) Foreign Application Priority Data
Apr. 23, 2020 (JP) 2020-076704

(51) Int. Cl. F04D 29/28; F04D 17/10

(52) U.S. Cl. CPC F04D 29/284; F04D 17/10

(57) ABSTRACT

An impeller includes: a disk-shaped hub centered on an axis; and a plurality of blades arranged in a circumferential direction and protruding from a surface of the hub facing one side in a direction of the axis. In a cross-sectional view including a blade height direction which is a direction away from the hub toward a tip of each blade, the blade has a recessed surface curved convexly toward a rear side in a rotational direction. In the cross-sectional view, when a distance between an imaginary line connecting a tip-side edge and a hub-side edge of the blade and a midspan of the blade along a direction perpendicular to the imaginary line is defined as a recess amount, the blade has a portion where the recess amount increases from a leading edge side to a trailing edge side.

### TECHNICAL FIELD

The present disclosure relates to an impeller and a centrifugal compressor.

The present application claims priority based on Japanese Patent Application No. 2020-076704 filed on Apr. 23, 2020, the entire content of which is incorporated herein by reference.

### BACKGROUND ART

An impeller used for a centrifugal compressor is equipped with a disk-shaped hub and a plurality of blades disposed on one surface of the hub.

In such an impeller, it is common practice to increase the circumferential component of the absolute flow velocity at the outlet by decreasing the backward angle of the blades in order to improve the pressure ratio. The backward angle is the angle formed by the tangent line at the trailing edge of the blade and the radial direction of the rotational axis. One illustrative example of the impeller having such a shape is disclosed in Patent Document 1.

### CITATION LIST

### Patent Literature

Patent Document 1: JP2014-109193A.

### SUMMARY

### Problems to be Solved

However, in the impeller having such a shape, the blade load is uniformly large from the hub to the tips of the blades, resulting in large losses due to flow structures such as secondary flow caused by the pressure gradient inside the impeller and leakage vortices at the blade tips. This may lead to a decrease in efficiency and a reduction in the stable operating area.

The present disclosure was made in view of the above, and an object thereof is to provide an impeller and a centrifugal compressor with high pressure ratio and high efficiency.

### Solution to the Problems

To solve the above problem, an impeller according to the present disclosure includes: a disk-shaped hub centered on an axis; and a plurality of blades arranged in the circumferential direction and protruding from a surface of the hub facing one side in the direction of the axis. In a cross-sectional view including a blade height direction from the hub to the tip of each blade, the blade has a recessed surface curved convexly toward the rear side in the rotational direction, and the blade has a portion where the curvature of the recessed surface increases from the leading edge side to the trailing edge side.

### Advantageous Effects

According to the present disclosure, it is possible to provide an impeller and a centrifugal compressor with high pressure ratio and high efficiency.

### BRIEF DESCRIPTION OF DRAWINGS

FIG. 1 is a cross-sectional view showing a configuration of a centrifugal compressor according to an embodiment of the present disclosure.

FIG. 2 is a perspective view showing a configuration of an impeller according to an embodiment of the present disclosure.

FIG. 3 is a meridian plane view showing a configuration of an impeller according to an embodiment of the present disclosure.

FIG. 4 is a diagram showing a blade angle distribution of an impeller according to an embodiment of the present disclosure.

FIG. 5A is a diagram showing the shape of a full blade in the blade height direction according to an embodiment of the present disclosure.

FIG. 5B is a diagram showing the shape of a full blade in the blade height direction according to an embodiment of the present disclosure.

FIG. 6 is a diagram for defining the blade angle of blades according to an embodiment of the present disclosure.

FIG. 7 is an explanatory diagram showing a relationship between the blade angle and the camber line of a full blade according to an embodiment of the present disclosure.

FIG. 8 is an explanatory diagram showing the state of secondary flow of an impeller according to an embodiment of the present disclosure.

### DETAILED DESCRIPTION

(Configuration of Centrifugal Compressor)

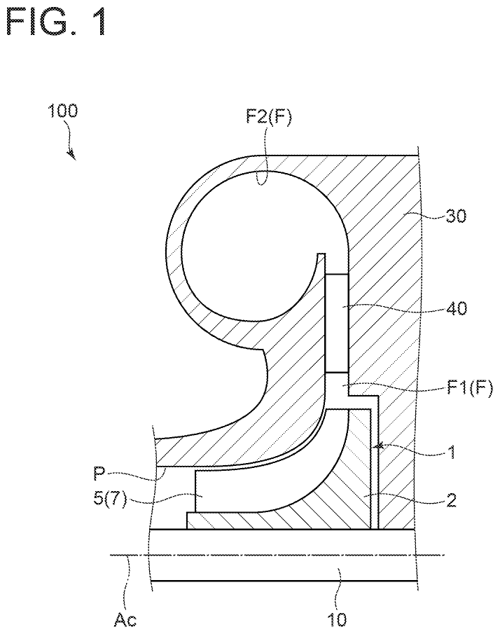

A centrifugal compressor 100 according to embodiments of the present disclosure will now be described with reference to FIGS. 1 to 8. As shown in FIG. 1, the centrifugal compressor 100 is provided with a rotational shaft 10, an impeller 1, a casing 30, and a diffuser vane 40. In the present invention, the diffuser vane 40 is not an essential configuration, and the present invention may be applied to a centrifugal compressor not provided with diffuser vanes.

The rotational shaft 10 extends along the axis Ac and is rotatable around the axis Ac. The impeller 1 is fixed to the outer peripheral surface of the rotational shaft 10. The impeller 1 has a hub 2 and a plurality of blades 5, 7 (full blades 5 and splitter blades 7).

The hub 2 has a disk shape centered on the axis Ac. The outer peripheral surface of the hub 2 has a curved surface shape that curves from inside to outside in the radial direction as it extends from one side to the other side in the direction of the axis Ac.

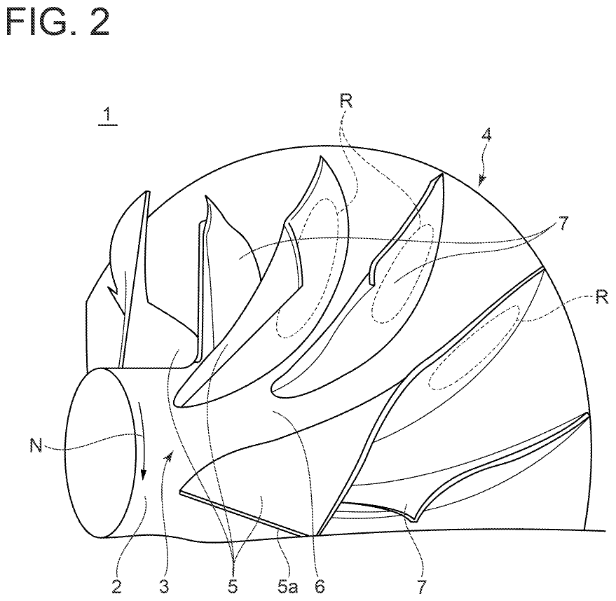

As shown in FIG. 2, the full blade 5 is a long blade disposed on the peripheral surface of the hub 2 so as to extend from an inlet portion 3 to an outlet portion 4 for a fluid. The splitter blade 7 is a short blade disposed in a passage 6 formed between each adjacent full blades 5 on the peripheral surface of the hub 2 so as to extend from the downstream side of a leading edge 5a of the full blade 5 to the outlet portion 4. The arrow (reference numeral N) in FIG. 2 indicates the rotational direction of the impeller 1.

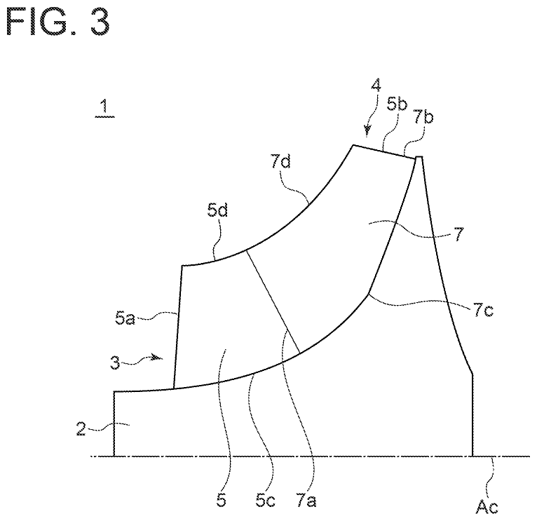

As shown in FIG. 3, the full blade 5 has a leading edge 5a which is an edge adjacent to the inlet portion 3, a trailing edge 5b which is an edge adjacent to the outlet portion 4, a hub-side edge 5c which is an edge on the side connected to the hub 2, and a tip-side edge 5d which is an edge opposite to the hub-side edge 5c. The splitter blade 7 has a leading edge 7a which is an edge adjacent to the inlet portion 3, a trailing edge 7b which is an edge adjacent to the outlet portion 4, a hub-side edge 7c which is an edge on the side connected to the hub 2, and a tip-side edge 7d which is an edge opposite to the hub-side edge 7c. Each tip-side edge 5d, 7d faces the inner wall surface of the casing (not shown), and a gap (hereinafter, referred to as “clearance”) is formed between the tip-side edge 5d, 7d and the inner wall surface of the casing. The detailed configuration of the full blade 5 will be described later.

The casing 30 surrounds the rotational shall 10 and the impeller 1 from the outer peripheral side. Inside the casing 30, a compression passage P for accommodating the impeller 1 and compressing a fluid guided from the outside, and an outlet passage F connected to the radially outer side of the compression passage P are formed.

The diameter of the compression passage P gradually increases from one side to the other side in the axis Ac direction in conformity with the outer shape of the impeller 1. The outlet passage F is connected to the outlet of the compression passage P on the radially outer side.

The outlet passage F has a diffuser passage F1 and an outlet scroll F2. The diffuser passage F1 is provided to recover the static pressure of the fluid guided from the compression passage P. The diffuser passage F1 has an annular shape extending outward in the radial direction from the outlet of the compression passage P. In a cross-sectional view including the axis Ac, the passage width of the diffuser passage F1 is constant over the entire extension direction. A plurality of diffuser vanes 40 may be provided in the diffuser passage F1.

The outlet scroll F2 is connected to the outlet of the diffuser passage F1 on the radially outer side. The outlet scroll F2 has a spiral shape extending in the circumferential direction of the axis Ac. The outlet scroll F2 has a circular passage cross-section. An exhaust hole (not shown) for guiding the high-pressure fluid to the outside is formed in a part of the outlet scroll F2.

(Configuration of Full Blade)

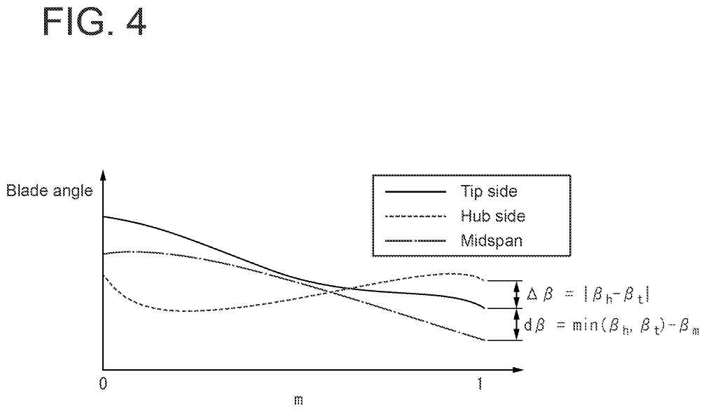

FIG. 4 shows the distribution of the blade angles of the hub-side edge 5c and the tip-side edge 5d of the full blade 5 from the leading edge 5a to the trailing edge 5b. In FIG. 4, the axis of ratio m of a length in the meridional length direction of the full blade 5 from the leading edge 5a of the full blade 5 to the meridional length of the full blade 5 is taken in the meridional length direction of the full blade 5. From the definition of m, m=0 for the position of the leading edge 5a and m=1 for the position of the trailing edge 5b, 7b. The fact that the value of m is the same means that the position when the impeller 1 is viewed from the meridional direction is the same. In FIG. 4, the solid line indicates the blade angle distribution of the tip-side edge 5d, the dashed line indicates the blade angle distribution of the hub-side edge 5c, and the dotted and dashed line indicates the blade angle distribution of a portion (midspan 5m) between the tip-side edge 5d and the hub-side edge 5c. Here, when the position of the hub-side edge 5c in the blade height direction is 0% spanwise position and the position of the tip-side edge 5d is 100% spanwise position, the position of the midspan 5m in FIG. 4 is 50% spanwise position (intermediate position between the tip-side edge 5d and the hub-side edge 5c). However, in the present invention, the position of the midspan 5m is not limited to 50% spanwise position. The position of a recessed surface R, which will be described later, may be defined, with the position of the midspan 5m being any spanwise position within the range of 30 to 70% spanwise position.

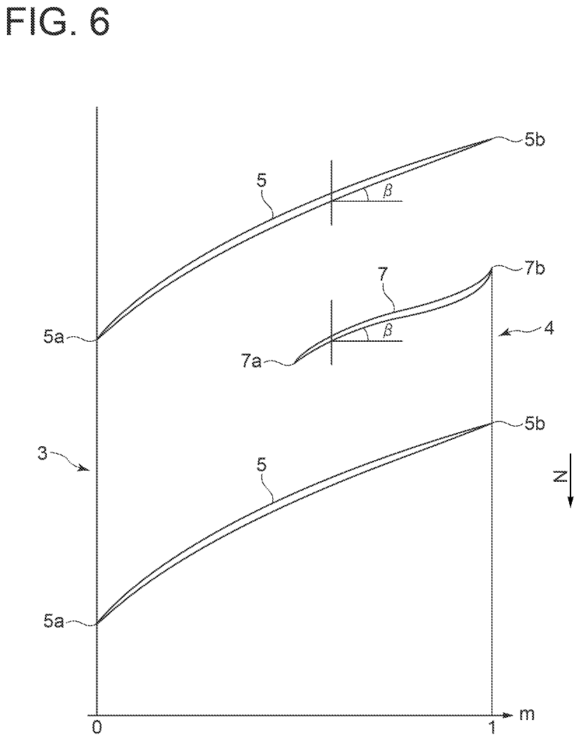

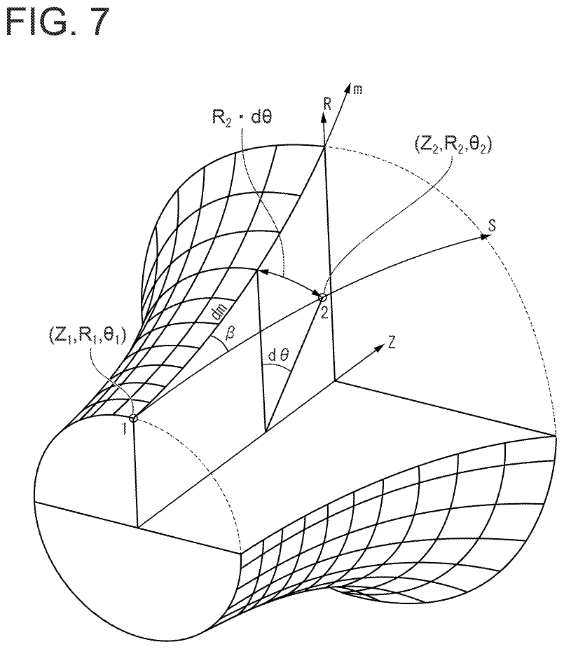

FIG. 6 is a developed view of the blade 5 on a plane from the inlet portion 3 to the outlet portion 4 along the meridional length direction at any spanwise position of the blade 5. In this developed view, the vertical axis represents the rotational direction of the blade 5, and the horizontal axis represents the meridional length direction. On this plane, the angle β formed by the blade (full blade 5 or splitter blade 7) and the meridional length direction is defined as the blade angle. That is, the blade angle β in the position of the trailing edge of the blade (backward angle) is the angle formed by the tangent line to the blade surface at the trailing edge of the blade and the meridional length direction. Further, referring to FIG. 7, in the coordinate system represented by the axial direction z, the radial direction R, and the rotation angle θ around the axis, the blade angle β in the small interval between the coordinate point 1 and the coordinate point 2 is defined by the following equation (1).

tan β=R2·dθ/dm (1)

Here, dθ=θ2−θ1, dm=√(Z₂−Z₁)²+(R₂−R₁)², and S is the camber line.

In the embodiment shown in FIG. 4, in the full blade 5, on the leading edge 5a side, the blade angle βt of the tip-side edge 5d is the largest, followed by the blade angle βm of the midspan 5m. Further, on the leading edge 5a side, the blade angle βh of the hub-side edge 5c is the smallest (βt>βm>βh). On the other hand, the blade angle distribution changes from the leading edge 5a side to the trailing edge 5b side. Specifically, on the trailing edge 5b side, the blade angle βh of the hub-side edge 5c is the largest, followed by the blade angle βt of the tip-side edge 5d. Further, on the trailing edge 5b side, the blade angle βm of the midspan 5m is the smallest (βh>βt>βm).

In an embodiment not shown, on the trailing edge 5b side, the blade angle βt of the tip-side edge 5d may be the largest. Further, the blade angle βt of the tip-side edge 5d may be equal to the blade angle βh of the hub-side edge 5c. Also in this case, on the trailing edge 5b side, the blade angle βm of the midspan 5m is the smallest (βt≥βh>βm).

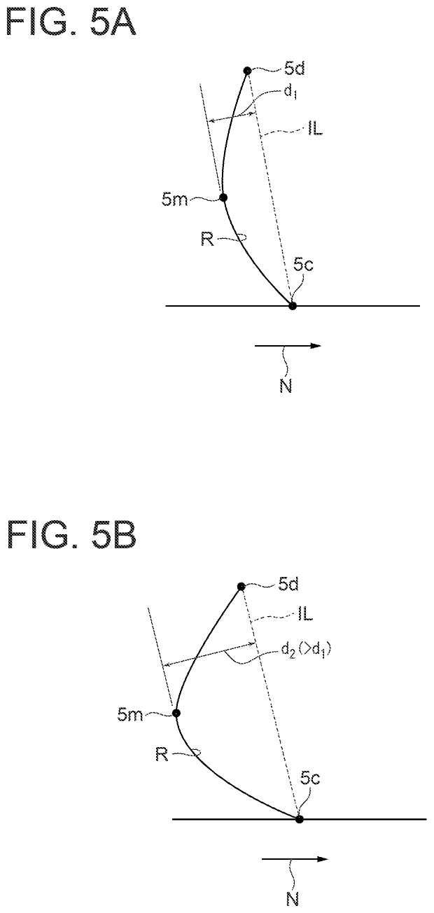

FIGS. 5A and 5B are each a diagram showing the shape of the blade in the blade height direction according to an embodiment of the present disclosure. FIGS. 5A and 5B show the shape (blade thickness center line) of the full blade in a portion ranging from 40 to 100% (m=0.4 to 1.0) from the leading edge, and FIG. 5A is closer to the leading edge 5a than FIG. 5B.

That is, as shown in FIGS. 2. 5A, and 5B, the blade angle distribution of FIG. 4 means that the blade 5 according to the present embodiment has a recessed surface R curved convexly toward the rear side in the rotational direction N a cross-sectional view including the blade height direction which is a direction away from the hub 2 toward the tip.

Further, in the cross-sectional view, when a distance between an imaginary line IL connecting the tip-side edge 5d and the hub-side edge 5c of the full blade 5 and the midspan of the blade along a direction perpendicular to the imaginary line is defined as a recess amount d, the full blade 5 has a portion where the recess amount d increases from the leading edge 5a side to the trailing edge 5b side (d₂>d₁). The recess amount d₂ at the midspan 5m in FIG. 5B is larger than the recess amount d₁ at the midspan 5m in FIG. 5A.

Further, as can be seen from FIG. 4, the full blade 5 has a portion where the curvature of the recessed surface R increases from the leading edge 5a side to the trailing edge 5b side. The curvature of the recessed surface R at the midspan 5m in FIG. 5B is larger than the curvature of the recessed surface R at the midspan 5m in FIG. 5A. Here, the curvature of the recessed surface R is defined as the reciprocal of the radius of curvature of the minimum imaginary circle that touches the recessed surface R at least two points.

The recessed surface R is preferably formed in at least part of a portion that is 40 to 100% (m=0.4 to 1.0) from the leading edge 5a of the full blade 5. Further, the recessed surface R is preferably formed in at least a portion that is 60% (m=0.6) from the leading edge 5a, where the secondary flow on the blade surface is particularly strong. Further, the portion of the recessed surface R with the largest curvature is preferably formed in a portion that is 60 to 70% (m=0.6 to 0.7) from the leading edge 5a of the full blade 5.

In the full blade 5 according to the present embodiment, as described above, in the position of the trailing edge 5b of the full blade 5, the blade angle βm at the midspan 5m is smaller than the blade angle βh on the hub side and the blade angle βt on the tip side.

Further, in the full blade 5 according to the present embodiment, as shown in FIG. 4, in the position of the trailing edge 5b of the full blade 5, a relationship of dβ>Δβ is satisfied, where dβ is a difference between the smaller one (min (βh, βt)) of the blade angle βh on the hub side or the blade angle βt on the tip side and the blade angle βm at the midspan 5m, and Δβ is an absolute value (|βh−βt|) of a difference between the blade angle βh on the hub side and the blade angle βt on the tip side. Preferably, a relationship of dβ>Δβ+2° is satisfied. More preferably, a relationship of dβ>Δβ+5° is satisfied.

(Operation and Effect)

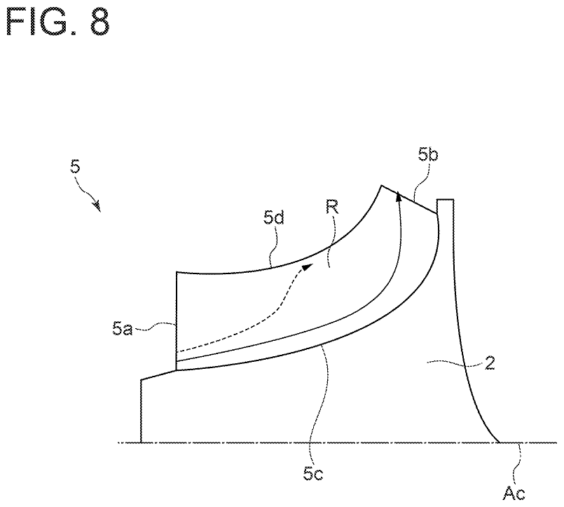

According to the above configuration, the full blade 5 has a recessed surface R curved convexly toward the rear side in the rotational direction. Further, the full blade 5 has a portion where the recess amount d increases from the leading edge 5a side to the trailing edge 5b side (d₂>d₁). As shown in FIG. 8, when a fluid flows along the full blade 5, the flow is actively drawn toward the recessed surface R. As a result, the secondary flow is captured by the recessed surface R and guided toward not the tip-side edge 5d but the trailing edge 5b (the solid line in FIG. 8). On the other hand, if there is no recessed surface R, as shown by the dashed arrow, the secondary flow flows from the leading edge 5a toward the tip-side edge 5d due to centrifugal force. As a result, the loss increases. In contrast, according to the present embodiment, it is possible to reduce the loss due to such a secondary flow. Thus, with the above configuration, the compression ratio of the impeller 1 can be increased by the amount that dβ is larger than Δβ.

Here, it is known that the secondary flow is likely to occur in a portion that is 40 to 100% from the leading edge of the blade, particularly a portion near 60% from the leading edge. With the above configuration, since the recessed surface is formed in a portion where the secondary flow is likely to occur, the secondary flow can be reduced actively.

According to the above configuration, in the position of the trailing edge 5b of the full blade 5, the blade angle βm of the midspan 5m is smaller than the blade angle βh on the hub side and the blade angle βt on the tip side. Further, as described above, a relationship of dβ>Δβ is satisfied. Preferably, a relationship of dβ>Δβ+2° is satisfied. More preferably, a relationship of dβ>Δβ+5° is satisfied.

Thus, the compression ratio of the impeller 1 can be increased by the amount dβ is larger than Δβ.

(Other Embodiments)

Embodiments of the present disclosure have been described specifically with reference to the drawings, but the specific configuration is not limited to these embodiments. Various modifications can be made without departing from the object of the present disclosure. For example, in the above-described embodiments, the case where the recessed surface R is formed on the full blade 5 has been described as an example, but the recessed surface R may be formed on the splitter blade 7.

<Appendix>

The impeller 1 and the centrifugal compressor 100 described in the above embodiments would be understood as follows, for instance.

(1) An impeller 1 according to the first aspect includes: a disk-shaped hub 2 centered on an axis Ac; and a plurality of blades 5 arranged in a circumferential direction and protruding from a surface of the hub 2 facing one side in a direction of the axis Ac. In a cross-sectional view including a blade height direction which is a direction away from the hub 2 toward a tip of each blade 5, the blade 5 has a recessed surface R curved convexly toward a rear side in a rotational direction. In the cross-sectional view, when a distance between an imaginary line IL connecting a tip-side edge 5d and a hub-side edge 5c of the blade 5 and a midspan 5m of the blade 5 along a direction perpendicular to the imaginary line IL is defined as a recess amount d, the blade 5 has a portion where the recess amount d increases from a leading edge side to a trailing edge side.

According to the above configuration, the blade 5 has a recessed surface curved convexly toward the rear side in the rotational direction. Further, the blade 5 has a portion where the recess amount d increases from the leading edge 5a side to the trailing edge 5b side. When a fluid flows along the blade 5, the flow is actively drawn toward the recessed surface R. As a result, the secondary flow is captured by the recessed surface R and guided toward not the tip but the trailing edge 5b. Consequently, the loss due to the secondary flow can be reduced, and the compression ratio of the impeller 1 can be increased.

(2) In the impeller 1 according to the second aspect, the portion where the recess amount d increases is configured such that a curvature of the recessed surface R increases from the leading edge side to the trailing edge side.

With the above configuration, since the portion where the recess amount d increases is configured such that the curvature of the recessed surface R increases from the leading edge side to the trailing edge side, the loss due to the secondary flow can be reduced more effectively, and the compression ratio of the impeller 1 can be increased.

(3) In the impeller 1 according to the third aspect, in a position of the trailing edge 5b of the blade 5, a blade angle βm at the midspan 5m between the hub-side edge 5c and the tip-side edge 5d of the blade 5 is smaller than a blade angle βh on the hub side and a blade angle βt on the tip side.

With the above configuration, since the backward angle (blade angle at trailing edge) of the midspan 5m is small compared to the hub 2 and the shroud, the pressure ratio can be improved without changing the load near the wall surface such as the hub 2 and the shroud, which are closely related to the secondary flow and leakage flow, as much as possible (while suppressing the pressure loss due to the flow structure as much as possible).

(4) In the impeller 1 according to the fourth aspect, the recessed surface R is formed in a portion that is 40 to 100% from the leading edge of the blade 5.

Here, it is known that the secondary flow is likely to occur particularly in a portion that is 40 to 100% from the leading edge 5b of the blade 5. With the above configuration, since the recessed surface R is formed in a portion where the secondary flow is likely to occur, the secondary flow can be reduced actively.

(5) In the impeller 1 according to the fifth aspect, in the third aspect, in a position of the trailing edge 5a of the blade 5, a relationship of dβ>Δβ is satisfied, where dβ is a difference between the smaller one of the blade angle βh on the hub side or the blade angle βt on the tip side and the blade angle βm at the midspan, and Δβ is an absolute value of a difference between the blade angle βh on the hub side and the blade angle βt on the tip side.

With the above configuration, it is possible to improve the effect described in the third aspect (3).

(6) In the impeller 1 according to the sixth aspect, in the fifth aspect (5), a relationship of dβ>Δβ+2° is satisfied.

With the above configuration, it is possible to further improve the effect described in the third aspect (3).

(7) A centrifugal compressor 100 according to the seventh aspect includes an impeller 1 and a casing 30 covering the impeller.

With the above configuration, it is possible to provide a centrifugal compressor with high pressure ratio and improved efficiency.

### REFERENCE SIGNS LIST

100 Centrifugal compressor

1 Impeller

2 Hub

3 Inlet portion

4 Outlet portion

5 Full blade

5a Leading edge

5b Trailing edge

5c Hub-side edge

5d Tip-side edge

5m Midspan

6 Passage

7 Splitter blade

10 Rotational shaft

30 Casing

40 Diffuser vane

Ac Axis

F Outlet passage

F1 Diffuser passage

F2 Outlet scroll

P Compression passage

R Recessed surface

P1 Plane

1. An impeller, comprising:
a disk shaped hub centered on an axis; and
a plurality of blades arranged in a circumferential direction and protruding from a surface of the hub facing one side in a direction of the axis,
wherein, in a cross-sectional view including a blade height direction which is a direction away from the hub toward a tip of each blade, the blade has a recessed surface curved convexly toward a rear side in a rotational direction,
wherein, in the cross-sectional view, when a distance between an imaginary line connecting a tip-side edge and a hub-side edge of the blade and a midspan of the blade along a direction perpendicular to the imaginary line is defined as a recess amount,
the blade has a portion where the recess amount increases from a leading edge side to a trailing edge side.

2. The impeller according to claim 1,
wherein the portion where the recess amount increases is configured such that a curvature of the recessed surface increases from the leading edge side to the trailing edge side.

3. The impeller according to claim 1,
wherein, in a position of the trailing edge of the blade, a blade angle at the midspan is smaller than a blade angle on the hub side and a blade angle on the tip side.

4. The impeller according to claim 1,
wherein the recessed surface is formed in at least part of a portion that is 40 to 100% from the leading edge of the blade.

5. The impeller according to claim 3,
wherein, in a position of the trailing edge of the blade, a relationship of dβ>Δβ is satisfied, where dβ is a difference between the smaller one of the blade angle on the hub side or the blade angle on the tip side and the blade angle at the midspan, and Δβ is an absolute value of a difference between the blade angle on the hub side and the blade angle on the tip side.

6. The impeller according to claim 5,
wherein a relationship of dβ>Δβ+2° is satisfied.

7. A centrifugal compressor, comprising:
the impeller according to claim 1; and
a casing covering the impeller.
